(19) United States
(12) Patent Application Publication
(10) Pub. No.: US 2025/0148317 A1
(43) Pub. Date: May 8, 2025

(54) Method and apparatus for generating prompt data based on knowledge graph

(71) Applicant: Alipay (Hangzhou) Information Technology Co., Ltd., Hangzhou (CN)

(72) Inventors: Deng ZHAO, Hangzhou (CN); Lei SHI, Hangzhou (CN); Bin HU, Hangzhou (CN); Jianshan HE, Hangzhou (CN)

(21) Appl. No.: 18/905,401

(22) Filed: Oct. 3, 2024

(30) Foreign Application Priority Data
Oct. 12, 2023 (CN) 202311325368.0

(51) Int. Cl. G06N 5/04; G06N 5/02

(52) U.S. Cl. CPC G06N 5/04; G06N 5/02

(57) ABSTRACT

Embodiments of this specification provide a method and an apparatus for generating a prompt based on a knowledge graph. In the method, a reasoning rule and an instance subgraph from the knowledge graph that match each other can be obtained in a plurality of manners. A question and answer template is constructed based on the reasoning rule. The question and answer template includes a question template and an answer template, and the answer template includes a cause template and a result template. A target text can be generated based on a combination of the question and answer template and the instance subgraph. The target text includes a question text and an answer text, and the answer text includes a cause text and a result text. The target text is used as a prompt to adjust a language model.

### TECHNICAL FIELD

One or more embodiments of this specification relate to the field of computer technologies, and in particular, to a method and an apparatus for generating a prompt based on a knowledge graph.

### BACKGROUND

Recently, a large language model has become popular worldwide. The large language model is a language model-based language generation technology, and can generate realistic natural language texts, including dialogues, stories, news, etc. People can intuitively perceive the great progress of the large language model in the fields of natural language understanding, natural language generation, etc. The language model is more widely applied, and can be further applied to machine translation, sentiment analysis, speech recognition, and other fields. With the application and development of the language model, people also recognize that there is room for improvement in correctness of facts understood by the language model in terms of natural language understanding, and there are still some limitations on credibility and controllability of generated content. A prompt has been proven to be valid in the language model. After the language model is obtained through training, the prompt can be used to direct the language model to provide a better answer. When the prompt includes privacy data, privacy protection needs to be performed on a process of generating and applying the prompt. How to generate a large quantity of high-quality prompts is a current problem.

Therefore, it is hoped that there can be an improved solution to efficiently generate a high-quality prompt, so as to improve a language prediction effect of the language model based on the prompt.

### SUMMARY

One or more embodiments of this specification describe a method and an apparatus for generating a prompt based on a knowledge graph, to efficiently generate a high-quality prompt. Specific technical solutions are as follows:

According to a first aspect, an embodiment provides a method for generating a prompt based on a knowledge graph, including:
obtaining a first reasoning rule and a matched first instance subgraph, where the first instance subgraph is from the knowledge graph, and the first reasoning rule includes a reasoning condition and a reasoning result;
obtaining a first question and answer template constructed based on the first reasoning rule, where the first question and answer template includes a question template and an answer template, the answer template includes a cause template and a result template, the question template and the result template are obtained by performing text conversion on the reasoning result, and the cause template is obtained by performing text conversion on the reasoning condition; and
generating a target text based on the first question and answer template and the first instance subgraph, where the target text includes a question text and an answer text, the answer text includes a cause text and a result text, and the target text is used as a prompt to adjust a language model.

In an implementation, the step of obtaining a first reasoning rule and a matched first instance subgraph includes:
obtaining several reasoning rules of the knowledge graph, where the several reasoning rules include the first reasoning rule; and
determining several instance subgraphs that match the first reasoning rule from the knowledge graph, where the several instance subgraphs include the first instance subgraph.

In an implementation, the step of obtaining a first reasoning rule and a matched first instance subgraph includes:
reading a first instance subgraph in the knowledge graph;
obtaining several reasoning rules of the knowledge graph; and
matching the first instance subgraph with the several reasoning rules, to obtain a matched first reasoning rule comprised by the several reasoning rules.

In an implementation, the step of reading a first instance subgraph in the knowledge graph includes:
receiving a to-be-queried first question text; and
determining a first instance subgraph associated with the first question text from the knowledge graph.

In an implementation, the question template is determined in the following manner:
converting a text corresponding to the reasoning result into a general question, and determining the question template based on a conversion result.

In an implementation, a text corresponding to the first reasoning rule includes several rule elements, and the several rule elements correspond to several instance elements in the first instance subgraph; and
the step of determining the question template based on a conversion result includes:
converting a text that is in the conversion result and that corresponds to the several rule elements into several to-be-filled slots, to obtain the question template.

In an implementation, the result template is determined in the following manner:
combining a preset word representing a meaning of “therefore” with a text corresponding to the reasoning result, and determining the result template based on a combination result.

In an implementation, the cause template is determined in the following manner:
combining a preset word representing a meaning of “because” with a text corresponding to the reasoning condition, and determining the cause template based on a combination result.

In an implementation, the result template further includes a to-be-filled probability descriptor; and
the step of generating a target text includes:
obtaining a first evaluation indicator of the first reasoning rule;
determining a probability descriptor corresponding to the first evaluation indicator from a preset correspondence between an evaluation indicator and a probability descriptor, filling the probability descriptor into the result template, and using a result template obtained after the filling as a prefilled result template; and
generating the target text based on the question template, the cause template, the prefilled result template, and the first instance subgraph.

In an implementation, the step of generating a target text includes:
obtaining a first evaluation indicator of the first reasoning rule;
determining a probability descriptor corresponding to the first evaluation indicator as a first probability descriptor from a preset correspondence between an evaluation indicator and a probability descriptor; and
generating the target text, so that the first probability descriptor is included at a predetermined location of the target text.

In an implementation, the first question and answer template includes several to-be-filled slots, and the several slots correspond to several rule elements in the first reasoning rule;
and the step of generating a target text includes:
determining several instance elements that are in the first instance subgraph and that correspondingly match the several rule elements, and filling the several instance elements into the several slots, to obtain the target text.

According to a second aspect, an embodiment provides an apparatus for generating a prompt based on a knowledge graph, including:
a data obtaining module, configured to obtain a first reasoning rule and a matched first instance subgraph, where the first instance subgraph is from the knowledge graph, and the first reasoning rule includes a reasoning condition and a reasoning result;
a template obtaining module, configured to obtain a first question and answer template constructed based on the first reasoning rule, where the first question and answer template includes a question template and an answer template, the answer template includes a cause template and a result template, the question template and the result template are obtained by performing text conversion on the reasoning result, and the cause template is obtained by performing text conversion on the reasoning condition; and
a text generation module, configured to generate a target text based on the first question and answer template and the first instance subgraph, where the target text includes a question text and an answer text, the answer text includes a cause text and a result text, and the target text is used as a prompt to adjust a language model.

According to a third aspect, an embodiment provides a computer-readable storage medium. The computer-readable storage medium stores a computer program. When the computer program is executed in a computer, the computer is enabled to perform the method in any implementation of the first aspect.

According to a fourth aspect, an embodiment provides a computing device, including a memory and a processor. The memory stores executable code. When the processor executes the executable code, the method in any implementation of the first aspect is implemented.

In the method and apparatus provided in the embodiments of this specification, a question and answer template is constructed by using a reasoning rule obtained from a knowledge graph, and the question and answer template is combined with an instance subgraph that matches the reasoning rule in the knowledge graph to generate a prompt. The question and answer template includes a question template and an answer template that includes a cause template and a result template. Therefore, a prompt generated based on the question and answer template includes a question text and an answer text that includes a cause text and a result text. A text including a reasoning process can be generated as a prompt by using the reasoning rule and high-quality data in the knowledge graph. This type of prompt is logically strong and highly efficient in a generation process.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show merely some embodiments of this specification, and a person of ordinary skill in the art can still derive other drawings from these accompanying drawings without creative efforts.

FIG. 1 is a schematic diagram of an implementation scenario of an embodiment disclosed in this specification;

FIG. 2 is a schematic flowchart of a method for generating a prompt based on a knowledge graph according to an embodiment;

FIG. 3 is a schematic diagram of structures of and a relationship between a first reasoning rule R1 and a first question and answer template QA1; and

FIG. 4 is a schematic block diagram of an apparatus for generating a prompt based on a knowledge graph according to an embodiment.

### DESCRIPTION OF EMBODIMENTS

The solutions provided in this specification are described below with reference to the accompanying drawings.

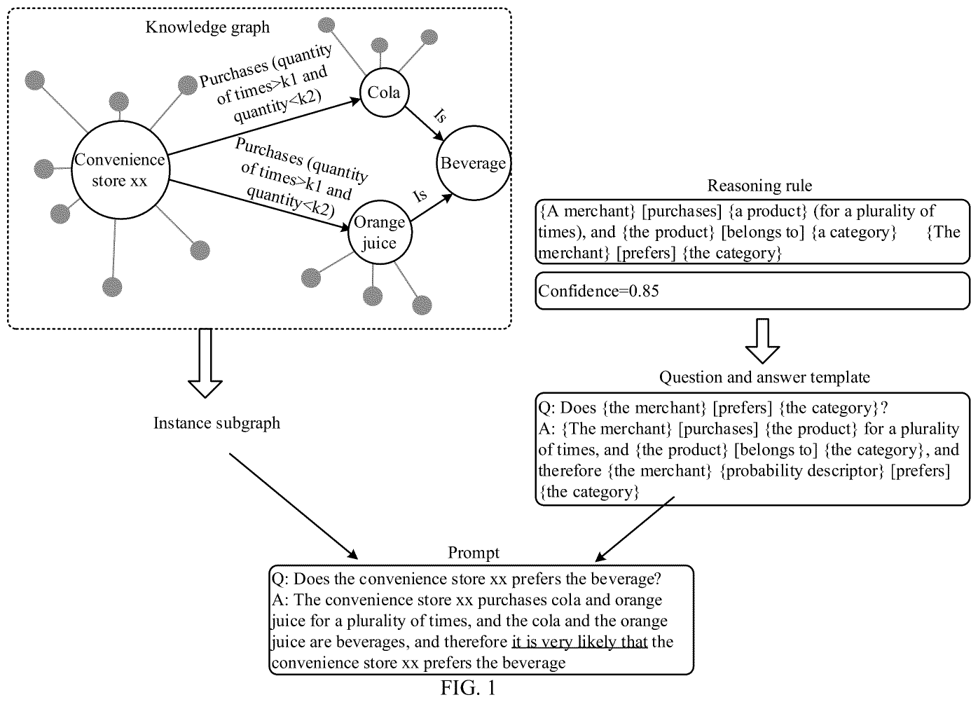

FIG. 1 is a schematic diagram of an implementation scenario of an embodiment disclosed in this specification. A corresponding question and answer template can be constructed based on a reasoning rule. An instance subgraph can be extracted from a knowledge graph. When a reasoning rule and an instance subgraph that match each other are obtained, the instance subgraph can be combined with a question and answer template corresponding to the reasoning rule to generate a prompt.

The knowledge graph is intended to describe various entities or concepts that exist in the real world and their relationships. The knowledge graph forms a huge semantic network graph, and is a knowledge base for expressing knowledge. The knowledge graph can express a large amount of complex knowledge in a more orderly manner. Data in the knowledge graph is usually characterized by high factual correctness, controllability, interpretability, etc. It should be emphasized that all information or data mentioned in the embodiments of this specification is used when authorization from a corresponding data object is obtained.

The knowledge graph includes a plurality of nodes representing entities and a connecting edge representing a relationship between nodes. The node and the connecting edge can be referred to as elements in the knowledge graph. Examples of some nodes and connecting edges in a knowledge graph are listed in FIG. 1. Circles and gray dots represent nodes, and connecting lines between nodes represent connecting edges. Gray dots and straight lines are schematic diagrams of more nodes and connecting edges. The entity is a thing in the real world, for example, a place name, a drug, an organization, an institution, a device, a number, etc. The entity can be represented by an entity word, and the entity word has a noun nature. For example, “cola”, “beverage”, etc. are entity names. The relationship is used to express a connection between different entities. For example, in a connection relationship “Cola-is-a beverage”, the relationship is “is”, reflecting relationship data such as “Cola is a beverage”.

In the knowledge graph, the node includes information such as a node name and a node type, and the connecting edge includes information such as a relationship type. For example, in the knowledge graph shown in FIG. 1, a node type of “convenience store xx” is “merchant”, node types of “cola” and “orange juice” are “product”, a relationship type between “convenience store xx” and “cola” is “purchases”, a relationship type between “convenience store xx” and “orange juice” is “purchases”, a relationship type between “cola” and “beverage” is “is”, and a relationship type between “cola” and “orange juice” is “is”. The relationship further includes a relationship attribute. Attributes of the relationship type “purchases” include quantity of times>k1 and quantity<k2.

The reasoning rule is obtained based on a node type and a relationship type in the knowledge graph, and is used as logic for summarization and reasoning. Rule elements in the reasoning rule include a node type, a relationship type, etc. The relationship type includes a relationship type existing in the knowledge graph and a predefined relationship type. The reasoning rule usually includes a reasoning condition and a reasoning result. With reference to the reasoning rule example shown in FIG. 1, “{A merchant} [purchases] {a product} (for a plurality of times), and {the product} [belongs to]{a category}→{The merchant} [prefers]{the category}” is a reasoning rule. The arrow follows a reasoning condition and is followed by a reasoning result, { } represents a node type, and [ ] represents a relationship type.

There can be a plurality of sources of the reasoning rule. For example, the reasoning rule can be obtained from the knowledge graph by using a rule extraction algorithm, or can be obtained through summarization by an expert based on experience. When outputting the reasoning rule, the rule extraction algorithm outputs an evaluation indicator such as a confidence and/or coverage of the reasoning rule. For example, in FIG. 1, the confidence of the reasoning rule is 0.85. The evaluation indicator is used to evaluate an effect of the reasoning rule. For example, the confidence is used to reflect the credibility of the reasoning rule, and the coverage is used to reflect a range of an instance subgraph hit by the reasoning rule in the knowledge graph. When a question and answer template is constructed, the evaluation indicator can be converted into a probability descriptor in the question and answer template. That the reasoning rule hits an instance subgraph in the knowledge graph can also be understood as that the reasoning rule matches the instance subgraph, or the instance subgraph meets the reasoning rule.

The instance subgraph is a relationship graph including several hops of neighbor nodes centered around a specific node in the knowledge graph. The instance subgraph can include several triples. The triples include a triple with a central node as a head node or a tail node, and a triple with a neighbor node of a central node as a head node or a tail node. The triple includes a head node, a connecting edge, and a tail node. For example, FIG. 1 shows an instance subgraph in which the convenience store xx is used as a central node in the knowledge graph.

A prompt is an input form or template designed by researchers for downstream tasks, to help a pre-trained language model “recall” what the language model has “learned” during pre-training. The prompt can further direct the pre-trained language model to perform fine tuning, to direct the language model to answer in a desired manner.

To more efficiently generate a high-quality prompt, the embodiments of this specification provide a method for generating a prompt based on a knowledge graph. The method includes the following steps: Step S210: Obtain a first reasoning rule and a matched first instance subgraph, where the first reasoning rule includes a reasoning condition and a reasoning result; step S220: Obtain a first question and answer template constructed based on the first reasoning rule, where the first question and answer template includes a question template and an answer template, the answer template includes a cause template and a result template, the question template and the result template are obtained by performing text conversion on the reasoning result, and the cause template is obtained by performing text conversion on the reasoning condition; and step S230: Generate a target text based on the first question and answer template and the first instance subgraph, where the target text includes a question text and an answer text, the answer text includes a cause text and a result text, and the target text is used as a prompt to adjust a language model.

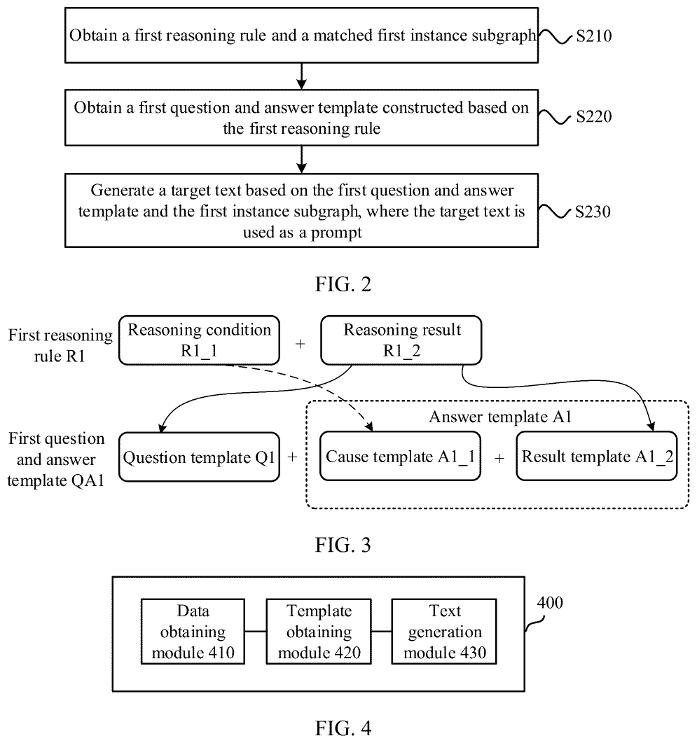

The following describes the embodiments in detail with reference to FIG. 2.

FIG. 2 is a schematic flowchart of a method for generating a prompt based on a knowledge graph according to an embodiment. The method is performed by a computing device, and the computing device can be implemented by any apparatus, device, platform, device cluster, etc. having computing and processing capabilities. The knowledge graph can be stored in the computing device, or can be stored in another device. There are one or more reasoning rules of the knowledge graph, and a first reasoning rule R1 is any one of several reasoning rules. A first instance subgraph G1 is any one of a plurality of instance subgraphs hit by the first reasoning rule R1. The instance subgraph is from the knowledge graph.

The following describes in detail the steps of the method for generating a prompt.

In step S210, the first reasoning rule R1 and the matched first instance subgraph G1 are obtained.

The first instance subgraph G1 is from the knowledge graph. The first reasoning rule R1 includes a reasoning condition R1_1 and a reasoning result R1_2.

This embodiment can be applied to a plurality of implementation scenarios. For example, this embodiment can be executed offline, and several reasoning rules are collected in advance, to generate a prompt. For another example, when online question answering is performed by using a language model, after a to-be-queried question is received, a prompt is generated based on the to-be-queried question, and the prompt is used to assist the language model in determining an answer to the to-be-answered question.

In an implementation, during execution, step S210 can include: obtaining several reasoning rules of the knowledge graph, where the several reasoning rules include the first reasoning rule R1; and determining several instance subgraphs that match the first reasoning rule R1 from the knowledge graph, where the several instance subgraphs include the first instance subgraph G1. When there are a large quantity of instance subgraphs that match the first reasoning rule R1 in the knowledge graph, the plurality of instance subgraphs can be sampled.

“Several” means “one or more”. An instance subgraph that matches the first reasoning rule R1 means that the instance subgraph meets the reasoning condition R1_1 in the first reasoning rule R1.

In an implementation, during execution, step S210 can include: reading a first instance subgraph G1 in the knowledge graph; obtaining several reasoning rules of the knowledge graph; and then matching the first instance subgraph G1 with each of the several reasoning rules, to obtain a matched first reasoning rule R1.

The reading a first instance subgraph G1 in the knowledge graph can be specifically determining a first instance subgraph G1 associated with a to-be-queried first question text from the knowledge graph when receiving the first question text. The first question text is any question text. When the first question text is received, an instance word in the first question text can be analyzed, and a first instance subgraph G1 corresponding to the entity word is determined from the knowledge graph based on the entity word.

In this embodiment, only the first reasoning rule and the matched first instance subgraph are used as examples to describe how to generate a prompt. When there are a plurality of reasoning rules and a plurality of instance subgraphs, a prompt can be generated for any reasoning rule and a corresponding instance subgraph by using the method provided in this embodiment.

In step S220, a first question and answer template QA1 constructed based on the first reasoning rule R1 is obtained.

A plurality of question and answer templates can be constructed based on the first reasoning rule R1, and the first question and answer template QA1 can be one of the plurality of question and answer templates. Primary parts of the plurality of question and answer templates can be the same, and words used in secondary parts of the plurality of question and answer templates can be different.

The step of constructing a first question and answer template QA1 can be that after pre-execution, the first question and answer template QA1 is stored in specified space, and the first question and answer template QA1 is obtained from the specified space when being required. Alternatively, the first question and answer template QA1 can be constructed in step S220.

FIG. 3 is a schematic diagram of structures of and a relationship between the first reasoning rule R1 and the first question and answer template QA1. The first question and answer template QA1 includes a question template Q1 and an answer template A1. The answer template A1 includes a cause template A1_1 and a result template A1_2. The question template Q1 and the result template A1_2 are obtained by performing text conversion on the reasoning result R1_2, and the cause template A1_1 is obtained by performing text conversion on the reasoning condition R1_1.

The computing device can construct the first question and answer template QA1 based on the first reasoning rule R1 and template construction logic. For example, the question template Q1 can be determined by using the following template construction logic: converting a text corresponding to the reasoning result R1_2 into a general question, and determining the question template Q1 based on a conversion result.

For example, for the reasoning result R1_2 “{The merchant}[prefers] {the category}” in the reasoning rule in FIG. 1, the text is converted into a general question, and a text “Does {the merchant} [prefer] {the category}” of a conversion result can be obtained.

There can be another type of template construction logic, and the text of the reasoning result is not necessarily converted into a general question. The text of the reasoning result can be converted into a special question based on a reasoning focus of the reasoning result. For example, a question about a subject or an object is asked.

The result template A1_2 can be determined by using the following template construction logic: combining a preset word representing a meaning of “therefore” with a text corresponding to the reasoning result R1_2, and determining the result template A1_2 based on a combination result. The word representing the meaning of “therefore” includes hence, so, therefore, etc. If different words are selected, different question and answer templates corresponding to the first reasoning rule R1 can be obtained. Specifically, the word representing the meaning of “therefore” can be placed in a start part or another part of the text corresponding to the reasoning result R1_2.

For example, for the reasoning result R1_2 “{The merchant} [prefers] {the category}” in the reasoning rule in FIG. 1, if “therefore” is placed in a start part of the reasoning result, an obtained combination result can be “therefore {the merchant} [prefers] {the category}”.

The cause template A1_1 can be determined by using the following template construction logic: combining a preset word representing a meaning of “because” with a text corresponding to the reasoning condition R1_1, and determining the cause template A1_1 based on a combination result. The word representing the meaning of “because” includes due to, because, etc. Specifically, the word representing the meaning of “because” can be placed in a start part or another part of the text corresponding to the reasoning condition R1_1.

For example, for the reasoning condition R1_1 “{A merchant} [purchases] {a product} (for a plurality of times), and {the product} [belongs to] {a category}” in the reasoning rule in FIG. 1, if “because” is placed in a start part of the reasoning condition, an obtained combination result can be “because {a merchant} [purchases] {a product} (for a plurality of times), and {the product} [belongs to] {a category}”. The combination result can be further more properly adjusted in terms of word order, to obtain “because {a merchant}[purchases] {a product} for a plurality of times, and {the product} [belongs to] {a category}”.

In specific implementation, when a text corresponding to the first reasoning rule R1 includes several rule elements, the several rule elements correspond to several instance elements in the first instance subgraph G1. The rule element can include a node type, a relationship type, and a custom type. The instance element includes a node and a relationship. The node herein can be replaced with a node name, and the relationship can be replaced with a relationship type.

The reasoning rule and the instance subgraph in FIG. 1 are used as examples for description. Rule elements in the reasoning rule include node types {merchant}, {product}, and {category}, relationship types [purchases], [is], and [prefers], etc. The relationship type [purchases] corresponds to the relationship type between “convenience store xx” and “cola” and the relationship type between “convenience store xx” and “orange juice” in the instance subgraph. The relationship type [is] corresponds to the relationship type between “cola” and “beverage” and the relationship type between “orange juice” and “beverage”. The relationship type [prefers] is a custom relationship type, and is also a relationship type derived from the reasoning rule. The node types {merchant}, {product}, and {category} correspond to node types in the instance subgraph.

When the question template Q1 is determined based on the conversion result, a text that is in the conversion result and that corresponds to the several rule elements can be converted into several to-be-filled slots, to obtain the question template Q1. Alternatively, the text may not be converted into a to-be-filled slot, but the text that is in the conversion result and that corresponds to the several rule elements is marked as a to-be-replaced character.

When the result template A1_2 is determined based on the combination result, a text that is in the combination result and that corresponds to the several rule elements is converted into several to-be-filled slots, to obtain the result template A1_2.

When the cause template A1_1 is determined based on the combination result, a text that is in the combination result and that corresponds to the several rule elements is converted into several to-be-filled slots, to obtain the cause template A1_1.

In step S230, a target text is generated based on the first question and answer template QA1 and the first instance subgraph G1, where the target text is used as a prompt. The target text includes a question text and an answer text, and the answer text includes a cause text and a result text. The target text is used as a prompt, and can be subsequently used to adjust a language model.

The target text can be obtained by combining the first question and answer template QA1 with the first instance subgraph G1. The first question and answer template QA1 includes elements corresponding to rule elements in the first reasoning rule R1, and the instance element in the first instance subgraph G1 corresponds to the rule element in the first reasoning rule R1. Therefore, a correspondence between the element in the first question and answer template QA1 and the instance element in the first instance subgraph G1 can be determined.

In an implementation, when the first question and answer template QA1 includes several to-be-filled slots, and the several slots correspond to several rule elements in the first reasoning rule R1, several instance elements that are in the first instance subgraph G1 and that correspondingly match the several rule elements can be determined, and the several instance elements can be filled into the several slots, to obtain the target text.

To enrich a meaning of the generated prompt, a correspondence between an evaluation indicator of a reasoning rule and a probability descriptor can be further preset. A larger evaluation indicator value indicates higher credibility or a higher occurrence possibility of a reasoning result and a higher possibility represented by a corresponding probability descriptor. The evaluation indicator can include a confidence and coverage. In Table 1, the confidence is used as an example, and a correspondence between different confidence values and probability descriptors is listed.

TABLE 1

| Confidence | Probability descriptor |
|---|---|
| Greater than or equal to 0.99 | Definitely |
| Greater than or equal to 0.95 | Almost |
| Greater than or equal to 0.90 | Highly likely |
| Greater than or equal to 0.85 | Very likely |
| . . . | . . . |

Higher closeness of the confidence value to 1 indicates a higher occurrence possibility.

In an implementation, a to-be-filled probability descriptor can be set in the result template A1_2. Specifically, a to-be-filled probability descriptor slot can be added. When the target text is generated in step S230, a first evaluation indicator of the first reasoning rule R1 can be obtained, a probability descriptor corresponding to the first evaluation indicator can be determined from the correspondence, the probability descriptor can be filled into the result template A1_2, and a result template obtained after the filling can be used as a prefilled result template. Then, the target text is generated based on the question template Q1, the cause template A1_1, the prefilled result template A1_2, and the first instance subgraph G1.

In an implementation, a probability descriptor can be added when the target text is generated. When step S230 is performed, a first evaluation indicator of the first reasoning rule R1 can be obtained, and a probability descriptor corresponding to the first evaluation indicator can be determined as a first probability descriptor from the correspondence. Then, the target text is generated, so that the first probability descriptor is included at a predetermined location of the target text. The predetermined location can be a text location set based on experience.

The reasoning rule and the question and answer template in FIG. 1 are used as examples below for description. The confidence of the reasoning rule is 0.85, and a corresponding probability descriptor is “very likely”. In the question template, [ ] and { } represent to-be-filled slots, a text in { } represents a node type, and a text in [ ] represents a relationship type. A correspondence between a question and answer template and an instance subgraph is listed in Table 2.

TABLE 2

| Question | Q: Does {the merchant} [prefers] {the category}? | | | | | | |
|---|---|---|---|---|---|---|---|
| and | A: {The merchant} [purchases] {the product} for a plurality of times, and {the | | | | | | |
| answer | product} [belongs to] {the category}, and therefore {the merchant} [prefers] {the | | | | | | |
| template | category }. | | | | | | |
| Instance | Node type | Convenience | Purchases | Cola | Orange | Is | Beverage |
| subgraph | or | store xx | | | juice | | |
| | relationship | | | | | | |
| | type | | | | | | |
| | Instance | Merchant | Purchases | Product | Product | Belongs | Category |
| | element | | | | | to | |

In Table 2, the first row is specific content of the question and answer template, and the second row is an instance element included in the instance subgraph and a corresponding node type or relationship type. The instance element is correspondingly filled into a to-be-filled slot. For example, the merchant “convenience store xx” is filled into the {merchant} slot, and the probability descriptor “very likely” is filled into the {probability descriptor} slot. After the filling, a target text shown in Table 3 is obtained.

TABLE 3

| | Does {the convenience store xx} | |
|---|---|---|
| Question text | [prefers] {the beverage}? | |
| Answer text | Cause text | {The convenience store xx} [purchases] {cola} |
| | | and {orange juice} for a plurality of times, and |
| | | {the cola} and {the orange juice} [are] |
| | | {beverages} |
| | Result text | Therefore {it is very likely that} {the |
| | | convenience store xx} [prefers] {the |
| | | beverage} |

In the question text and the answer text, { } and [ ] merely represent that there are originally to-be-filled slots herein, and the actual text does not include the symbols.

In this embodiment, the generated prompt includes the question text and the answer text, and the answer text is divided into the cause text and the result text. In this way, a result obtaining process is more clearly displayed by using the prompt. In addition, the evaluation indicator of the reasoning rule is converted into a corresponding probability descriptor and added to the prompt. Therefore, the prompt is semantically richer and the answer is more accurate.

The language model in this embodiment is a natural language processing model trained based on a deep learning technology and a large-scale corpus. By learning a large quantity of language samples, the language model can learn language structures and rules, and can generate proper natural language texts. The language model can be applied to the fields of question and answer, machine translation, text generation, sentiment analysis, speech recognition, etc., and is one of important technologies in natural language processing. The language model in this embodiment can include a large language model and a small/medium language model.

The method for generating a prompt provided in this embodiment can be automatically performed in batches by using the computing device. This reduces manual participation, and can significantly improve efficiency. A large quantity of reasoning rules are accumulated in the knowledge graph. These reasoning rules are descriptions at a schema level, and the schema is defined. Therefore, the question and answer template can directly use the schema, to efficiently generate a prompt.

The prompt generated in this embodiment is logically strong. In a process of constructing the question and answer template, both a type constraint of the schema and a reasoning rule constraint are met. Therefore, a logically strong prompt can be obtained. The logically strong prompt helps improve a logic capability and a reasoning capability of the language model. There is a correspondence between an evaluation indicator and a probability descriptor. Therefore, in this embodiment, an accurate descriptor can be added to the prompt, so that the prompt is more accurately described, to facilitate more refined learning and reasoning of the language model.

In this embodiment, the prompt is generated by using the reasoning rule, so that the reasoning rule is reused. In addition, data in the knowledge graph is verified and constrained by the schema, and is of higher quality.

In this specification, “first” in words such as the first reasoning rule, the first instance subgraph, the first question and answer template, and the first evaluation indicator and corresponding “second” (if present) in this specification are merely used for ease of distinguishing and description, and have no limitation meaning.

Specific embodiments of this specification are described above, and other embodiments fall within the scope of the appended claims. In some cases, the actions or steps described in the claims can be performed in a sequence different from that in the embodiments and desired results can still be achieved. In addition, the process depicted in the accompanying drawings does not necessarily need a particular sequence or consecutive sequence to achieve the desired results. In some implementations, multitasking and parallel processing are possible or may be advantageous.

FIG. 4 is a schematic block diagram of an apparatus for generating a prompt based on a knowledge graph according to an embodiment. The apparatus embodiment corresponds to the method embodiment shown in FIG. 2. The apparatus 400 is deployed in a computing device. The computing device can be implemented by any apparatus, device, platform, device cluster, etc. having computing and processing capabilities. The apparatus 400 includes:
a data obtaining module 410, configured to obtain a first reasoning rule and a matched first instance subgraph, where the first instance subgraph is from the knowledge graph, and the first reasoning rule includes a reasoning condition and a reasoning result;
a template obtaining module 420, configured to obtain a first question and answer template constructed based on the first reasoning rule, where the first question and answer template includes a question template and an answer template, the answer template includes a cause template and a result template, the question template and the result template are obtained by performing text conversion on the reasoning result, and the cause template is obtained by performing text conversion on the reasoning condition; and
a text generation module 430, configured to generate a target text based on the first question and answer template and the first instance subgraph, where the target text includes a question text and an answer text, the answer text includes a cause text and a result text, and the target text is used as a prompt to adjust a language model.

In an implementation, the data obtaining module 410 includes a first obtaining submodule and a first determining submodule (not shown in the figure);
the first obtaining submodule is configured to obtain several reasoning rules of the knowledge graph, where the several reasoning rules include the first reasoning rule; and
the first determining submodule is configured to determine several instance subgraphs that match the first reasoning rule from the knowledge graph, where the several instance subgraphs include the first instance subgraph.

In an implementation, the data obtaining module 410 includes a first reading submodule, a second obtaining submodule, and a first matching submodule (not shown in the figure);
the first reading submodule is configured to read a first instance subgraph in the knowledge graph;
the second obtaining submodule is configured to obtain several reasoning rules of the knowledge graph; and
the first matching submodule is configured to match the first instance subgraph with each of the several reasoning rules, to obtain a matched first reasoning rule.

In an implementation, the first reading submodule is specifically configured to:
receive a to-be-queried first question text; and
determine a first instance subgraph associated with the first question text from the knowledge graph.

In an implementation, the apparatus 400 further includes a first determining module (not shown in the figure), configured to determine the question template in the following manner:
converting a text corresponding to the reasoning result into a general question, and determining the question template based on a conversion result.

In an implementation, a text corresponding to the first reasoning rule includes several rule elements, and the several rule elements correspond to several instance elements in the first instance subgraph; and
when the first determining module determines the question template based on the conversion result, the following operation is performed:
converting a text that is in the conversion result and that corresponds to the several rule elements into several to-be-filled slots, to obtain the question template.

In an implementation, the apparatus 400 further includes a second determining module (not shown in the figure), configured to determine the result template in the following manner:
combining a preset word representing a meaning of “therefore” with a text corresponding to the reasoning result, and determining the result template based on a combination result.

In an implementation, the apparatus 400 further includes a third determining module (not shown in the figure), configured to determine the cause template in the following manner:
combining a preset word representing a meaning of “because” with a text corresponding to the reasoning condition, and determining the cause template based on a combination result.

In an implementation, the result template further includes a to-be-filled probability descriptor; and the text generation module 430 includes a third obtaining submodule, a second determining submodule, and a first generation submodule (not shown in the figure);
the third obtaining submodule is configured to obtain a first evaluation indicator of the first reasoning rule;
the second determining submodule is configured to: determine a probability descriptor corresponding to the first evaluation indicator from a preset correspondence between an evaluation indicator and a probability descriptor, fill the probability descriptor into the result template, and use a result template obtained after the filling as a prefilled result template; and
the first generation submodule is configured to generate the target text based on the question template, the cause template, the prefilled result template, and the first instance subgraph.

In an implementation, the text generation module 430 includes a fourth obtaining submodule, a third determining submodule, and a second generation submodule (not shown in the figure);
the fourth obtaining submodule is configured to obtain a first evaluation indicator of the first reasoning rule;
the third determining submodule is configured to determine a probability descriptor corresponding to the first evaluation indicator as a first probability descriptor from a preset correspondence between an evaluation indicator and a probability descriptor; and
the second generation submodule is configured to generate the target text, so that the first probability descriptor is included at a predetermined location of the target text.

In an implementation, the first question and answer template includes several to-be-filled slots, and the several slots correspond to several rule elements in the first reasoning rule;
and the text generation module 430 is specifically configured to:
determine several instance elements that are in the first instance subgraph and that correspondingly match the several rule elements, and fill the several instance elements into the several slots, to obtain the target text.

The apparatus embodiments correspond to the method embodiments. For specific descriptions, references can be made to the descriptions in the method embodiments. Details are omitted here for simplicity. The apparatus embodiments are obtained based on the corresponding method embodiments, and have the same technical effects as the corresponding method embodiments. For specific descriptions, references can be made to the corresponding method embodiments.

An embodiment of this specification further provides a computer-readable storage medium. The computer-readable storage medium stores a computer program. When the computer program is executed in a computer, the computer is enabled to perform the method in any one of FIG. 1 to FIG. 3.

An embodiment of this specification further provides a computing device, including a memory and a processor. The memory stores executable code. When the processor executes the executable code, the method in any one of FIG. 1 to FIG. 3 is implemented.

The embodiments of this specification are described in a progressive manner. For the same or similar parts of the embodiments, mutual references can be made between the embodiments. Each embodiment focuses on a difference from other embodiments. In particular, the embodiments of the storage medium and the computing device are basically similar to the method embodiments, and therefore are described briefly. For related parts, references can be made to some descriptions in the method embodiments.

A person skilled in the art should be aware that in the above-mentioned one or more examples, functions described in the embodiments of this specification can be implemented by hardware, software, firmware, or any combination thereof. When being implemented by software, these functions can be stored in a computer-readable medium or transmitted as one or more instructions or code on a computer-readable medium.

The objectives, technical solutions, and beneficial effects of the embodiments of this specification are further described in detail in the specific implementations described above. It should be understood that the above-mentioned descriptions are merely specific implementations of the embodiments of this specification, and are not intended to limit the protection scope of this specification. Any modification, equivalent replacement, improvement, etc. made based on the technical solutions in this specification shall fall within the protection scope of this specification.

1. A method for generating a prompt based on a knowledge graph, comprising:
obtaining a first reasoning rule and a matched first instance subgraph, wherein the first instance subgraph is from the knowledge graph, and the first reasoning rule comprises a reasoning condition and a reasoning result;
obtaining a first question and answer template constructed based on the first reasoning rule, wherein the first question and answer template comprises a question template and an answer template, the answer template comprises a cause template and a result template, the question template and the result template are obtained by performing text conversion on the reasoning result, and the cause template is obtained by performing text conversion on the reasoning condition; and
generating a target text based on the first question and answer template and the first instance subgraph, wherein the target text comprises a question text and an answer text, the answer text comprises a cause text and a result text, and the target text is used as a prompt to adjust a language model.

2. The method according to claim 1, wherein the step of obtaining a first reasoning rule and a matched first instance subgraph comprises:
obtaining several reasoning rules of the knowledge graph, wherein the several reasoning rules comprise the first reasoning rule; and
determining several instance subgraphs that match the first reasoning rule from the knowledge graph, wherein the several instance subgraphs comprise the first instance subgraph.

3. The method according to claim 1, wherein the step of obtaining a first reasoning rule and a matched first instance subgraph comprises:
reading a first instance subgraph in the knowledge graph;
obtaining several reasoning rules of the knowledge graph; and
matching the first instance subgraph with the several reasoning rules, to obtain a matched first reasoning rule comprised by the several reasoning rules.

4. The method according to claim 3, wherein the step of reading a first instance subgraph in the knowledge graph comprises:
receiving a to-be-queried first question text; and
determining a first instance subgraph associated with the first question text from the knowledge graph.

5. The method according to claim 1, wherein the question template is determined in the following manner:
converting a text corresponding to the reasoning result into a general question, and determining the question template based on a conversion result.

6. The method according to claim 5, wherein a text corresponding to the first reasoning rule comprises several rule elements, and the several rule elements correspond to several instance elements in the first instance subgraph; and
the step of determining the question template based on a conversion result comprises:
converting a text that is in the conversion result and that corresponds to the several rule elements into several to-be-filled slots, to obtain the question template.

7. The method according to claim 1, wherein the result template is determined in the following manner:
combining a preset word representing a meaning of “therefore” with a text corresponding to the reasoning result, and determining the result template based on a combination result.

8. The method according to claim 1, wherein the cause template is determined in the following manner:
combining a preset word representing a meaning of “because” with a text corresponding to the reasoning condition, and determining the cause template based on a combination result.

9. The method according to claim 1, wherein the result template further comprises a to-be-filled probability descriptor; and
the step of generating a target text comprises:
obtaining a first evaluation indicator of the first reasoning rule;
determining a probability descriptor corresponding to the first evaluation indicator from a preset correspondence between an evaluation indicator and a probability descriptor, filling the probability descriptor into the result template, and using a result template obtained after the filling as a prefilled result template; and
generating the target text based on the question template, the cause template, the prefilled result template, and the first instance subgraph.

10. The method according to claim 1, wherein the step of generating a target text comprises:
obtaining a first evaluation indicator of the first reasoning rule;
determining a probability descriptor corresponding to the first evaluation indicator as a first probability descriptor from a preset correspondence between an evaluation indicator and a probability descriptor; and
generating the target text, so that the first probability descriptor is comprised at a predetermined location of the target text.

11. The method according to claim 1, wherein the first question and answer template comprises several to-be-filled slots, and the several slots correspond to several rule elements in the first reasoning rule; and the step of generating a target text comprises:
determining several instance elements that are in the first instance subgraph and that correspondingly match the several rule elements, and filling the several instance elements into the several slots, to obtain the target text.

12. (canceled)

13. A non-transitory computer-readable storage medium, comprising instructions stored therein that, when executed by a processor of a computing device, cause the computing device to:
obtain a first reasoning rule and a matched first instance subgraph, wherein the first instance subgraph is from a knowledge graph, and the first reasoning rule comprises a reasoning condition and a reasoning result;
obtain a first question and answer template constructed based on the first reasoning rule, wherein the first question and answer template comprises a question template and an answer template, the answer template comprises a cause template and a result template, the question template and the result template are obtained by performing text conversion on the reasoning result, and the cause template is obtained by performing text conversion on the reasoning condition; and
generate a target text based on the first question and answer template and the first instance subgraph, wherein the target text comprises a question text and an answer text, the answer text comprises a cause text and a result text, and the target text is used as a prompt to adjust a language model.

14. A computing device, comprising a memory and a processor, wherein the memory stores executable instructions that, in response to execution by the processor, cause the computing device to:
obtain a first reasoning rule and a matched first instance subgraph, wherein the first instance subgraph is from a knowledge graph, and the first reasoning rule comprises a reasoning condition and a reasoning result;
obtain a first question and answer template constructed based on the first reasoning rule, wherein the first question and answer template comprises a question template and an answer template, the answer template comprises a cause template and a result template, the question template and the result template are obtained by performing text conversion on the reasoning result, and the cause template is obtained by performing text conversion on the reasoning condition; and
generate a target text based on the first question and answer template and the first instance subgraph, wherein the target text comprises a question text and an answer text, the answer text comprises a cause text and a result text, and the target text is used as a prompt to adjust a language model.

15. The computing device according to claim 14, wherein the computing device being caused to obtain a first reasoning rule and a matched first instance subgraph comprises being caused to:
obtain several reasoning rules of the knowledge graph, wherein the several reasoning rules comprise the first reasoning rule; and
determine several instance subgraphs that match the first reasoning rule from the knowledge graph, wherein the several instance subgraphs comprise the first instance subgraph.

16. The computing device according to claim 14, wherein the computing device being caused to obtain a first reasoning rule and a matched first instance subgraph comprises being caused to:
read a first instance subgraph in the knowledge graph;
obtain several reasoning rules of the knowledge graph; and
match the first instance subgraph with the several reasoning rules, to obtain a matched first reasoning rule comprised by the several reasoning rules.

17. The computing device according to claim 16, wherein the computing device being caused to read a first instance subgraph in the knowledge graph comprises being caused to:
receive a to-be-queried first question text; and
determine a first instance subgraph associated with the first question text from the knowledge graph.

18. The computing device according to claim 14, wherein the computing device is further caused to:
convert a text corresponding to the reasoning result into a general question, and determine the question template based on a conversion result.

19. The computing device according to claim 18, wherein a text corresponding to the first reasoning rule comprises several rule elements, and the several rule elements correspond to several instance elements in the first instance subgraph; and
the computing device being caused to determine the question template based on a conversion result comprises being caused to:
convert a text that is in the conversion result and that corresponds to the several rule elements into several to-be-filled slots, to obtain the question template.

20. The computing device according to claim 14, wherein the computing device is further caused to:
combine a preset word representing a meaning of “therefore” with a text corresponding to the reasoning result, and determine the result template based on a combination result.

21. The computing device according to claim 14, wherein the computing device is further caused to:
combine a preset word representing a meaning of “because” with a text corresponding to the reasoning condition, and determine the cause template based on a combination result.
